(19) United States
(12) Patent Application Publication
(10) Pub. No.: US 2005/0185893 A1
(43) Pub. Date: Aug. 25, 2005

(54) Method and apparatus for tapering an optical waveguide

(76) Inventor: Ansheng Liu, Cupertino, CA (US)

Correspondence Address: James Y. Go;BLAKELY, SOKOLOFF, TAYLOR & ZAFMAN LLP, Seventh Floor, 12400 Wilshire Boulevard, Los Angeles, CA, 90025, US

(21) Appl. No.: 10/783,526

(22) Filed: Feb. 20, 2004

(51) Int. Cl. G02B 6/26

(52) U.S. Cl. 385/50; 385/43

(57) ABSTRACT

An apparatus and method for reducing a mode size of an optical beam. In one embodiment, an apparatus according to embodiments of the present invention includes a first optical waveguide disposed in a first semiconductor material of a semiconductor layer. The first optical waveguide includes an inverted tapered inner core disposed in an untapered outer core of the first optical waveguide. The inverted tapered inner core includes a smaller end and a larger end. The apparatus further includes a second optical waveguide disposed in a second semiconductor material of the semiconductor layer. The second optical waveguide is a tapered optical waveguide having a larger end and a smaller end. The larger end of the second optical waveguide is disposed proximate to the larger end of the inverted tapered inner core of the first optical waveguide such that an optical beam is to be directed from the smaller end to the larger end of the first optical waveguide to the larger end to the smaller end of the second optical waveguide.

### BACKGROUND OF THE INVENTION

1. Field of the Invention

The present invention relates generally to optics and, more specifically, the present invention relates to optical waveguide tapers.

2. Background Information

The need for fast and efficient optical-based technologies is increasing as Internet data traffic growth rate is overtaking voice traffic pushing the need for optical communications. Transmission of multiple optical channels over the same fiber in the dense wavelength-division multiplexing (DWDM) systems and Gigabit (GB) Ethernet systems provide a simple way to use the unprecedented capacity (signal bandwidth) offered by fiber optics. Commonly used optical components in the system include wavelength division multiplexed (WDM) transmitters and receivers, optical filter such as diffraction gratings, thin-film filters, fiber Bragg gratings, arrayed-waveguide gratings, optical add/drop multiplexers, lasers and optical switches.

Many of these building block optical components can be implemented in semiconductor devices. As such, these devices are typically connected to an optical fiber and it is therefore important to obtain an efficient coupling of light between the fiber and the semiconductor device containing the optical components. Light is typically propagated through the optical fibers and optical waveguides in semiconductor devices as a single mode. Three-dimensional tapered waveguides or mode size converters are important to realize efficient light coupling between a single mode fiber and a single mode semiconductor waveguide device because semiconductor waveguide devices usually have smaller mode sizes compared to optical fiber mode sizes. This is usually because of the large index contrast of semiconductor waveguide systems and the required smaller waveguide dimensions for the device performance such as high speed in a silicon based photonic device.

Previous attempts at three-dimensional tapered waveguides or mode size converters include various tapering schemes and fabrication methods that are for example based on gray scale lithography technology, which requires a complicated etch process. Other attempts include taper methods that are difficult to combine with the electrically active photonic device processes, which typically involves many back-end process steps.

### BRIEF DESCRIPTION OF THE DRAWINGS

The present invention is illustrated by way of example and not limitation in the accompanying figures.

FIG. 1 is an illustration of one embodiment of a tapered waveguide device including a first optical waveguide with an inverted tapered inner core and a second optical waveguide that is tapered in accordance with the teachings of the present invention.

FIG. 2 is a side view diagram of one embodiment of a tapered waveguide device illustrating a mode of an optical beam propagating through sthe first optical waveguide with the inverted tapered inner core and the second optical waveguide that is tapered in accordance with the teachings of the present invention.

FIG. 3 is a cross section view of one embodiment of a smaller or tip end of an inverted tapered inner core of tapered waveguide device in accordance with the teachings of the present invention.

FIG. 4 is a diagram illustrating the relationship between optical coupling loss and the tip width of one embodiment of a smaller end of an inverted tapered inner core of tapered waveguide device in accordance with the teachings of the present invention.

FIG. 5 is a cross section view of one embodiment of a larger end of an inverted tapered inner core of tapered waveguide device in accordance with the teachings of the present invention.

FIG. 6 is a cross section view of one embodiment of a larger end of the second optical waveguide that is tapered in accordance with the teachings of the present invention.

FIG. 7 is a cross section view of one embodiment of a smaller end of the second optical waveguide that is tapered or a third optical waveguide showing an optical beam after an optical mode of the optical beam has been shrunk in accordance with the teachings of the present invention.

FIG. 8 is a block diagram illustration of one embodiment of a system including one embodiment a semiconductor device including a tapered waveguide device and a photonic device according to embodiments of the present invention.

### DETAILED DESCRIPTION

Methods and apparatuses reducing or shrinking a mode size of an optical beam with a tapered waveguide device including a first optical waveguide with an inverted tapered inner core and a second optical waveguide that is tapered are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. In addition, it is appreciated that the figures provided herewith are for explanation purposes to persons ordinarily skilled in the art and that the drawings are not necessarily drawn to scale. Furthermore, it is also appreciated that the specific dimensions, index values, materials, etc. illustrated herewith are provided for explanation purposes and that other suitable dimensions, index values, materials, etc. may also be utilized in accordance with the teachings of the present invention.

In one embodiment of the present invention, a novel tapered waveguide device including a first optical waveguide with an inverted tapered inner core and a second optical waveguide that is tapered is disclosed. Embodiments of the disclosed tapered waveguide device have low optical coupling loss and may be utilized with miniaturized single mode semiconductor based waveguides enabling high-speed operation with semiconductor based photonic devices such as for example silicon based optical modulators, micro-ring resonators, photonic band gap devices and the like.

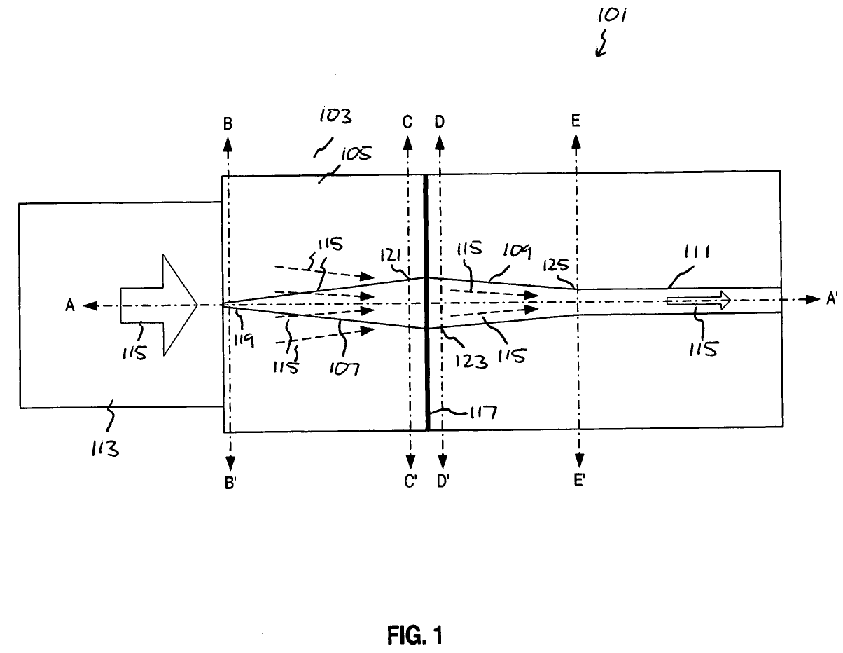

In one embodiment of the present invention, a tapered waveguide device includes a silicon oxynitride (SiON) waveguide taper monolithically integrated in a semiconductor layer with a tapered silicon rib waveguide to shrink the mode size of an optical beam. To illustrate, FIG. 1 shows one embodiment of a tapered waveguide device 101 disposed in semiconductor material in accordance with the teachings of the present invention. As shown in the depicted embodiment, tapered waveguide device 101 is disposed in a semiconductor layer and includes a first optical waveguide 103 and a second optical waveguide 109.

In one embodiment, first optical waveguide includes an inverted tapered inner core 107 disposed in an untapered outer core 105. In the illustrated embodiment, inverted tapered inner core 107 is a strip waveguide and includes a tip end or smaller end 119 and a larger end 121. In one embodiment, inverted tapered inner core 107 and untapered outer core 105 are made of a first semiconductor material such as SiON. In one embodiment in particular, inverted tapered inner core 107 includes SiON having an index of refraction of for example n≈1.8 and untapered outer core 105 includes SiON having an index of refraction of for example n≈1.46. In one embodiment, inverted tapered inner core 107 and untapered outer core 105 of first optical waveguide 103 are covered by an oxide having an index of refraction of for example n≈1.44.

Continuing with the embodiment depicted in FIG. 1, second optical waveguide 109 is a tapered optical waveguide having a larger end 123 and a smaller end 125. In one embodiment, second optical waveguide is a rib waveguide and the larger end 123 of second optical waveguide 109 is disposed proximate to the larger end 121 of inverted tapered inner core 107. In one embodiment, the smaller end 125 of second optical waveguide is disposed proximate to a third optical waveguide 111 disposed in the same semiconductor layer. In one embodiment, third optical waveguide 111 is a rib waveguide. In one embodiment, second and third optical waveguides 109 and 111 are each made of a second semiconductor material such as silicon (Si), having an index of refraction of for example n≈3.48.

In operation, the example embodiment of FIG. 1 shows that an optical fiber 113 directs an optical beam 115 into the first optical waveguide 103 of tapered waveguide device 101 proximate to the smaller end 119 of inverted tapered inner core 107. In one embodiment, the tip width of the smaller end 119 is substantially small such that substantially all of optical beam 115 is directed into the untapered outer core 105 when directed into first optical waveguide 103.

As will be discussed, the relatively small tip width of smaller end 119 of inverted tapered inner core 107 results in tapered waveguide device 101 exhibiting a substantially small optical coupling loss in accordance with the teachings of the present invention. In one embodiment, with SiON included in inverted tapered inner core 107 and untapered outer core 105 of first optical waveguide 103, the tip width of smaller end 119 of inverted tapered core 107 is approximately equal to 0.08 μm and the tip height of smaller end 119 is approximately equal to 1 μm. In various embodiments, it is appreciated that inverted tapered inner core 107 may be linearly, nonlinearly or piece-wisely linearly tapered in accordance with the teachings of the present invention.

Continuing with the described example, as optical beam 115 propagates along first optical waveguide 103 from the smaller end 119 towards the larger end 121, substantially all of optical beam 115 is directed from the untapered outer core 105 into the inverted tapered inner core 107 since inverted tapered inner core 107 has a higher index of refraction than the index of refraction of untapered outer core 105 and the size of the inner core 107 becomes large enough to support a guided mode as the tip width is increased. As such, the optical mode of optical beam 115 is shrunk or reduced in accordance with the teachings of the present invention.

Continuing further with the described example, optical beam 115 is then directed from first optical waveguide 103 into the second optical waveguide 109 to further reduce the size of the optical mode of optical beam 115 in accordance with the teachings of the present invention. In one embodiment, since inverted tapered inner core 107 of first optical waveguide 103 includes SiON having an index of refraction of for example n≈1.8 and second optical waveguide includes Si having an index of refraction of for example n≈3.48, an antireflective region 117 is disposed between first and second optical waveguides 103 and 109 in the semiconductor layer to reduce any reflection of optical beam 115 when propagating between first and second optical waveguides 103 and 109. In one embodiment, antireflective region 117 includes for example silicon nitride (Si₃N₄) and has an index of refraction of for example n≈2.0.

As optical beam 115 propagates along second optical waveguide 109 from larger end 123 to smaller end 125, the optical mode size of optical beam 115 is further shrunk or reduced since second optical waveguide 109 is a tapered optical waveguide. As shown in the depicted embodiment, optical beam 115 is then directed from second optical waveguide 109 to the third optical waveguide 111. With the inverted tapered inner core 107 disposed in untapered outer core 105 of first optical waveguide 103 and tapered optical waveguide of second optical waveguide 109, it is appreciated optical beam 115 is directed into third optical waveguide 111 with a reduced optical mode size with low optical coupling loss in accordance with the teachings of the present invention.

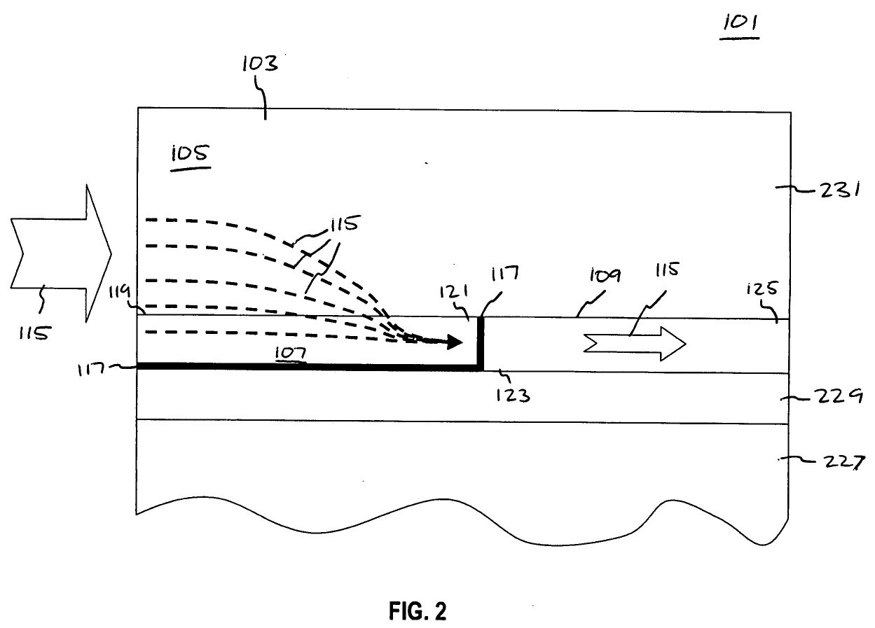

FIG. 2 is a side view cross-section diagram of one embodiment of a tapered waveguide device 101 along dashed line A-A′ of FIG. 1. As illustrated in FIG. 2, one embodiment of tapered waveguide device 101 is fabricated in an epitaxial layer 231 of a semiconductor wafer such as for example a silicon-on-insulator (SOI) wafer. As such, the SOI wafer in the illustrated embodiment includes a buried insulating layer 229 disposed between the epitaxial semiconductor layer 231 and a semiconductor substrate 227. In one embodiment, buried insulating layer 229 includes oxide and epitaxial semiconductor layer 231 and semiconductor substrate 227 include Si.

In operation, optical beam 115 is directed into first optical waveguide 103, which includes the inverted tapered inner core 107 disposed in the untapered outer core 105. As shown in FIG. 2, as optical beam 115 propagates along first optical waveguide 103 from smaller end 119 towards larger end 121 of inverted tapered inner core 107, substantially all of the optical mode of optical beam 115 is directed from untapered outer core 105 into inverted tapered inner core 107. As such, the mode size of optical beam is reduced or shrunk by the time that optical beam 115 is directed from the inverted tapered inner core 107 of first optical waveguide 103 through the antireflective region 117 into second optical waveguide 109.

In one embodiment, as optical beam 115 propagates along the tapered optical waveguide of second optical waveguide 109 from larger end 123 towards smaller end 125 the optical mode of optical beam 115 is further reduced in accordance with the teachings of the present invention. In one embodiment, it is noted that as optical beam 115 propagates along inverted tapered inner core 107 and along second optical waveguide 109, the oxide of buried insulating layer 229 and the SiON included in untapered outer core 105 in the epitaxial semiconductor layer 231 of the SOI wafer serve is cladding to help provide optical confinement of optical beam 115 within inverted tapered inner core 107 and second optical waveguide 109.

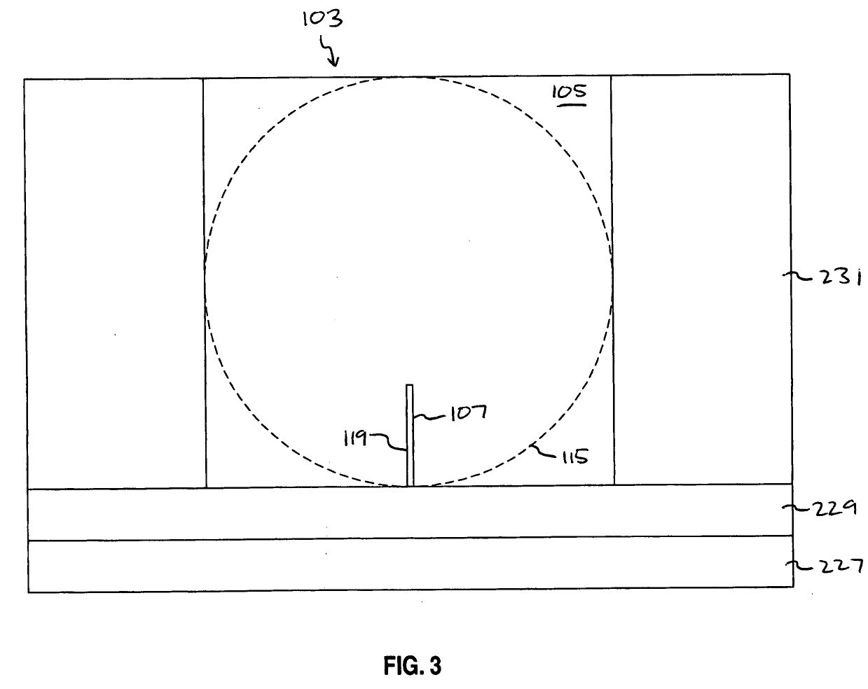

FIG. 3 is a cross section view of one embodiment of the first optical waveguide 103 through the untapered outer core 105 and the smaller end 119 of inverted tapered inner core 107 along dashed line B-B′ of FIG. 1. As illustrated in FIG. 3, first optical waveguide 103 in one embodiment is disposed in the epitaxial semiconductor layer 231 of the SOI wafer, and buried insulating layer 229 is disposed between epitaxial semiconductor layer 231 and semiconductor substrate 227.

In one embodiment, the smaller end 119 of inverted tapered inner core 107 has a tip width of approximately 0.08 μm and a tip height of approximately 1 μm while untapered outer core 105 has a height and width of approximately 10×10 μm. As mentioned previously, inverted tapered inner core 107 in one embodiment includes SiON having an index of refraction of approximately 1.8, which is greater than the index of refraction of the untapered outer core 105, which in one embodiment includes SiON having an index of refraction of approximately 1.46. With the tip width of inverted tapered inner core 107 at smaller end 119 adequately small and with the selection of materials and refractive indexes as discussed, substantially all of optical beam 115 is directed into untapered outer core 105 with a relatively small amount of optical coupling loss in accordance with the teachings of the present invention.

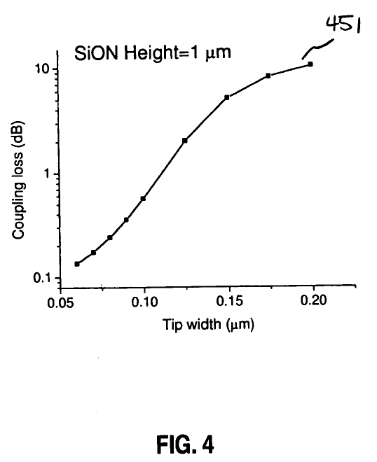

To illustrate, FIG. 4 is a plot 451 illustrating a relationship between optical coupling loss and the tip width of one embodiment of smaller end 119 of inverted tapered inner core 107 of tapered waveguide device 101 in accordance with the teachings of the present invention. In the illustrated example, optical fiber 113 is assumed to be a single mode optical fiber and the height of inverted tapered inner core 107 is assumed to be approximately 1 μm. In addition, the index of refraction of the inverted tapered inner core 107 is assumed to be approximately 1.8 and the index of refraction of the untapered outer core 105 is assumed to be approximately 1.46.

As shown in the illustration, plot 451 shows that less than 1.0 dB/facet optical fiber-to-optical waveguide coupling loss is obtainable for example with a 1×1 μm silicon rib waveguide. In particular, plot 451 shows that a relatively small optical loss of approximately 0.24 dB may be obtained with a tip width of approximately 0.08 μm. In one embodiment of the present invention, a relatively tip width of approximately 0.08 μm or less for the smaller end 119 of inverted tapered inner core 107 is realized with known high resolution lithographic techniques or by the use of known double mask schemes. Plot 451 also shows that there is a relatively rapid increase in optical coupling loss as the tip width is increased. It is appreciated that is because the fundamental mode of the 10×10 μm SiON waveguide as shown strongly depends on the inner core dimension. When the inner core size is larger than 0.1 μm, the fundamental mode is mainly determined by the inner core so that the overlap between the optical fiber mode and the fundamental mode is small.

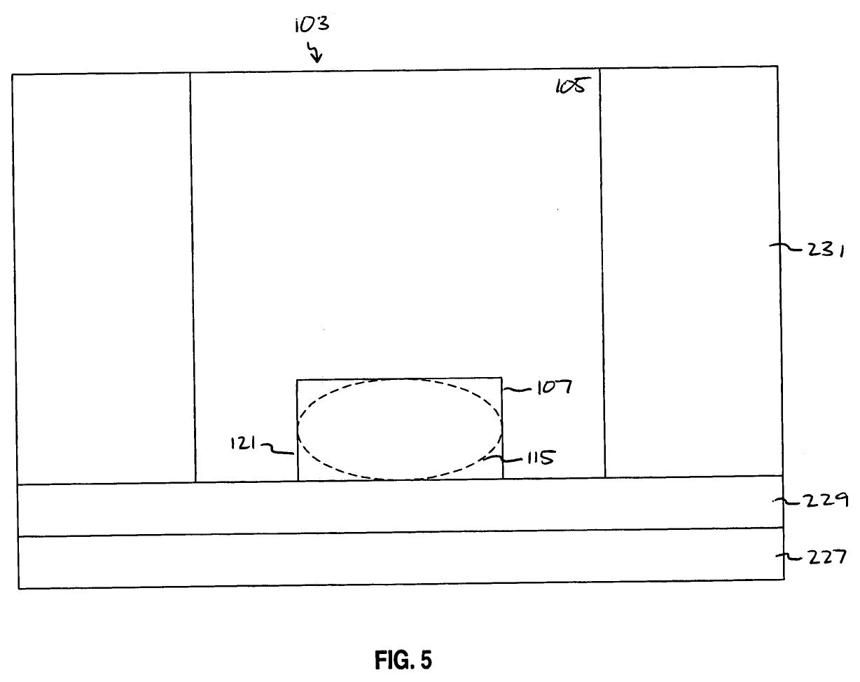

FIG. 5 is a cross section view of one embodiment of the first optical waveguide 103 through the untapered outer core 105 and the larger end 121 of inverted tapered inner core 107 along dashed line C-C′ of FIG. 1. As illustrated in FIG. 5, the width of tapered inner core 107 at larger end 121 is substantially wider than the tip width of tapered inner core 107 at smaller end 119. In one embodiment, the width of tapered inner core 107 at larger end 121 is approximately 2 μm and the height of tapered inner core 107 at larger end 121 is approximately 1 μm while the height and width of untapered outer core 105 is approximately 10 μm by 10 μm

As shown in the depicted embodiment, substantially all of optical beam 115 has been directed into the inverted tapered inner core 107 by the time optical beam 115 has propagated to the larger end 121 of inverted tapered inner core 107 in accordance with the teachings of the present invention. As mentioned above with respect to FIG. 1, optical beam 115 in one embodiment is then directed into second optical waveguide 109 through antireflective region 117.

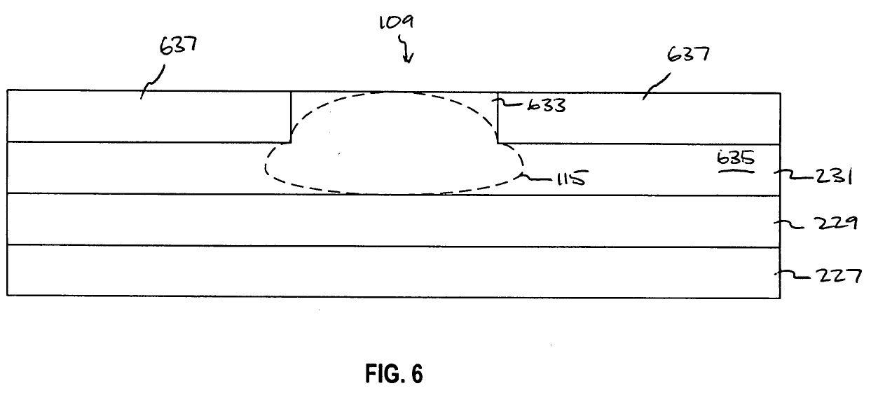

FIG. 6 is a cross section view of one embodiment of the second optical waveguide 109 at the larger end 123 of the tapered optical waveguide along dashed line D-D′ of FIG. 1. As illustrated in FIG. 6, one embodiment of second optical waveguide 109 is disposed in the epitaxial semiconductor layer 231 of the SOI wafer, with buried insulating layer 229 disposed between epitaxial semiconductor layer 231 and semiconductor substrate 227.

In one embodiment, second optical waveguide 109 is a rib waveguide disposed in Si having a rib region 633 and a slab region 635. In one embodiment, the Si of second optical waveguide 109 has an index of refraction of approximately 3.48. In one embodiment, the rib waveguide of second optical waveguide 109 has a total height of approximately 1 μm and the rib region 633 has a height of approximately 0.5 μm. At the larger end 123 of the tapered optical waveguide of second optical waveguide 109, the width of rib region 633 is approximately 2 μm. In one embodiment, insulating regions 637 are disposed on opposites lateral sides of rib region 633 to serve as cladding with buried insulating region 229 to help confine optical beam 115 to remain within second optical waveguide 109 as shown in FIG. 6. In one embodiment, the fundamental modes at the larger end of first waveguide 103 and at the larger end of second waveguide 109 are substantially similar. Therefore, the optical loss is small when light propagates through the junction between first and second waveguides in accordance with the teachings of the present invention. In one embodiment, insulating regions 637 may include for example an oxide material or the same or similar SiON material as that used in untapered outer core 105 of first optical waveguide 103.

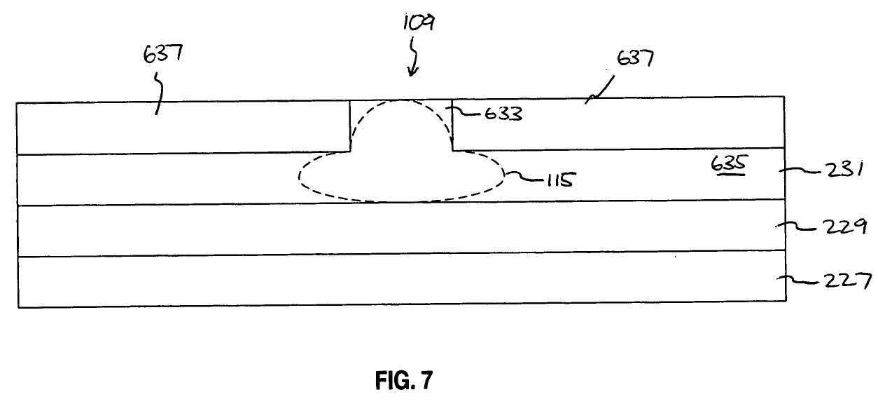

FIG. 7 is a cross section view of one embodiment of the second optical waveguide 109 at the smaller end 125 of the tapered optical waveguide along dashed line E-E′ of FIG. 1. In one embodiment, it is noted that a cross section view of second optical waveguide 109 at the smaller end 125 is the same as or substantially similar to a cross section view of third optical waveguide 111. Therefore, in one embodiment, a description of cross section view of one embodiment of the second optical waveguide 109 at the smaller end 125 as illustrated in FIG. 7 also applies to a cross section view of third optical waveguide 111.

As shown in the depicted embodiment, the rib waveguide of second optical waveguide 109 at smaller end 125 has been tapered to a rib width of approximately 1 μm compared to the approximately 2 μm width at larger end 123. In the illustrated embodiment, the rib waveguide has a total height of approximately 1 μm and the rib region 633 has a height of approximately 0.5 μm. With insulating regions 637 and buried insulating region 229 serving as cladding, optical beam 115 is confined to remain within second optical waveguide 109 and the size of the optical mode of optical beam 115 has been shrunk or reduced accordingly in accordance with the teachings of the present invention. With the reduced size of the optical mode of optical beam 115, optical beam 115 in one embodiment may then be directed through third optical waveguide 111 to other devices such as for example a photonic device or devices disposed in the semiconductor layer in accordance with the teachings of the present invention.

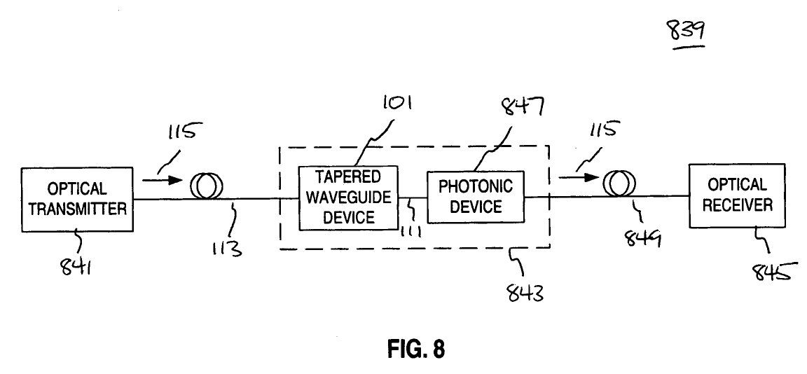

FIG. 8 is a block diagram illustration of one embodiment of a system 839 including one embodiment a semiconductor device including tapered waveguide device and a photonic device according to embodiments of the present invention. As illustrated in the depicted embodiment, system 839 includes an optical transmitter 841 to output an optical beam 115. System 839 also includes an optical receiver 845 and an optical device 843 that is optically coupled between the optical transmitter 841 and optical receiver 845. In one embodiment, the optical device 843 includes semiconductor material, such as for example an epitaxial silicon layer in a chip, with a tapered waveguide device 101 and a photonic device 847 included therein. In one embodiment, tapered waveguide device 101 is substantially similar to tapered waveguide device 101 described in FIGS. 1-7 above. In one embodiment, tapered waveguide device 101 and photonic device 847 are semiconductor-based devices that are provided in a fully and monolithically integrated solution on a single integrated circuit chip.

In operation, optical transmitter 841 transmits optical beam 115 to optical device 843 through an optical fiber 113. Optical fiber 113 is then optically coupled to optical device 843 such that optical beam 115 is received at an input tapered waveguide device 101. In one embodiment, the input to taper waveguide device 101 corresponds to an end of first optical waveguide 103 proximate to the smaller end 119 of inverted tapered inner core 107. Accordingly, tapered waveguide device 101, the mode size of optical beam 114 is reduced in size such that a photonic device 847 receives optical beam 847 through a single mode waveguide, such as for example third optical waveguide 111 disposed in the semiconductor material of optical device 843. In one embodiment, photonic device 847 may include any known semiconductor-based photonic optical device including for example, but not limited to, an optical phase shifter, modulator, switch or the like. After optical beam 115 is output from photonic device 847, it is then optically coupled to be received by optical receiver 845. In one embodiment, optical beam 115 is propagated through an optical fiber 849 to propagate from optical device 843 to optical receiver 845.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

1. An apparatus, comprising:
a first optical waveguide disposed in a first semiconductor material of a semiconductor layer, the first optical waveguide including an inverted tapered inner core disposed in an untapered outer core of the first optical waveguide, wherein the inverted tapered inner core includes a smaller end and a larger end; and
a second optical waveguide disposed in a second semiconductor material of the semiconductor layer, wherein the second optical waveguide is a tapered optical waveguide having a larger end and a smaller end, wherein the larger end of the second optical waveguide is disposed proximate to the larger end of the inverted tapered inner core of the first optical waveguide such that an optical beam is to be directed from the smaller end to the larger end of the first optical waveguide to the larger end to the smaller end of the second optical waveguide.

2. The apparatus of claim 1 wherein the inverted tapered core of the first optical waveguide has an index of refraction that is greater than an index of refraction of the untapered outer core of the untapered outer core.

3. The apparatus of claim 1 further comprising an antireflective region disposed in the semiconductor layer between the larger end of the second optical waveguide and the larger end of the inverted tapered inner core of the first optical waveguide.

4. The apparatus of claim 3 wherein the antireflective region has an index of refraction that is in between an index of refraction of the inverted tapered core of the first optical waveguide and an index of refraction of the second optical waveguide.

5. The apparatus of claim 1 further comprising a third optical waveguide disposed in the second semiconductor material in the semiconductor layer, the third optical waveguide optically coupled to the smaller end of the second optical waveguide such that the optical beam is directed from the smaller end of the second optical waveguide into the third optical waveguide.

6. The apparatus of claim 5 wherein the second and third optical waveguides have substantially equal indexes of refraction.

7. The apparatus of claim 5 wherein the second and third optical waveguides are rib waveguides disposed in the semiconductor layer.

8. The apparatus of claim 1 wherein the first semiconductor material includes silicon oxynitride (SiON) and the second semiconductor material includes silicon (Si).

9. The apparatus of claim 3 wherein the antireflective region includes silicon nitride (Si₃N₄).

10. The apparatus of claim 1 wherein a tip width of the smaller end of the inverted tapered inner core of the first optical waveguide is less than a tip width of the smaller end of the second optical waveguide.

11. A method, comprising:
directing an optical beam into an untapered outer core of a first optical waveguide disposed in first semiconductor material in a semiconductor layer;
directing the optical from the untapered outer core of a first optical waveguide into an inverted tapered inner core of the first optical waveguide disposed in the first semiconductor material in the semiconductor layer as the optical beam propagates along the first optical waveguide from a smaller end to a larger end of the inverted tapered inner core of the first optical waveguide; and
directing the optical beam from the larger end of the inverted tapered inner core of the first optical waveguide into a second optical waveguide disposed in a second semiconductor material of the semiconductor layer, wherein the second optical waveguide is a tapered optical waveguide having a larger end and a smaller end, wherein the optical beam is directed into larger end of the second optical waveguide.

12. The method of claim 11 further comprising directing the optical beam from the smaller end of the second optical waveguide into a third optical waveguide in the second semiconductor material of the semiconductor layer.

13. The method of claim 11 further comprising shrinking a mode size of the optical beam by directing the optical beam into the untapered outer core of a first optical waveguide and then directing the optical beam from the larger end of the inverted tapered inner core of the first optical waveguide.

14. The method of claim 12 further comprising shrinking a mode size of the optical beam by directing the optical beam into the larger end of the second optical waveguide and then directing the optical beam from the smaller end of the second optical waveguide.

15. The method of claim 11 wherein directing the optical from the untapered outer core of the first optical waveguide into the inverted tapered inner core of the first optical waveguide comprises directing the optical beam from a material having a lower index of refraction into a material having a higher index of refraction.

16. The method of claim 11 further comprising directing the optical beam through an antireflective region when directing the optical beam from the larger end of the inverted tapered inner core of the first optical waveguide into the larger end of the second optical waveguide.

17. The method of claim 16 wherein directing the optical beam through the antireflective region when directing the optical beam from the larger end of the inverted tapered inner core into the larger end of the second optical waveguide comprises directing the optical beam through a region having an index of refraction value that is between index of refraction values of the first and second semiconductor materials.

18. A system, comprising:
an optical transmitter to transmit an optical beam;
an optical receiver;
an optical device disposed between the optical transmitter and the optical receiver, the optical device including:
a first optical waveguide disposed in a first semiconductor material of a semiconductor layer, the first optical waveguide including an inverted tapered inner core disposed in an untapered outer core of the first optical waveguide, wherein the inverted tapered inner core includes a smaller end and a larger end; and
a second optical waveguide disposed in a second semiconductor material of the semiconductor layer, wherein the second optical waveguide is a tapered optical waveguide having a larger end and a smaller end, wherein the larger end of the second optical waveguide is disposed proximate to the larger end of the inverted tapered inner core of the first optical waveguide such that an optical beam is to be directed from the smaller end to the larger end of the first optical waveguide to the larger end to the smaller end of the second optical waveguide; and
a photonic device disposed in the second semiconductor material in the semiconductor layer optically coupled to the smaller end of the second optical waveguide, the optical beam coupled to be received by the photonic device through the first and second optical waveguides, the optical beam to be directed through the photonic device to the optical receiver.

19. The system of claim 18 further comprising an optical fiber optically coupled between the optical transmitter and the first optical waveguide.

20. The apparatus of claim 18 wherein the inverted tapered core of the first optical waveguide has an index of refraction that is greater than an index of refraction of the untapered outer core of the untapered outer core.

21. The apparatus of claim 18 further comprising an antireflective region disposed in the semiconductor layer between the larger end of the second optical waveguide and the larger end of the inverted tapered inner core of the first optical waveguide.

22. The apparatus of claim 21 wherein the antireflective region has an index of refraction that is in between an index of refraction of the inverted tapered core of the first optical waveguide and an index of refraction of the second optical waveguide.

23. The apparatus of claim 18 further comprising a third optical waveguide disposed in the second semiconductor material in the semiconductor layer, the third optical waveguide optically coupled between the smaller end of the second optical waveguide and the photonic device.

24. The apparatus of claim 18 wherein the first semiconductor material includes silicon oxynitride (SiON) and the second semiconductor material includes silicon (Si).

25. The apparatus of claim 21 wherein the antireflective region includes silicon nitride (Si₃N₄).
